(19) United States
(12) Patent Application Publication
(10) Pub. No.: US 2006/0121421 A1
(43) Pub. Date: Jun. 8, 2006

(54) IT equipment simulation

(76) Inventors: James S. Spitaels, Worcester, MA (US); Neil Rasmussen, Concord, MA (US); James W. VanGilder, Pepperell, MA (US); John H. Bean JR., Wentzville, MO (US); David N. Susek, (US)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 11/252,032

(22) Filed: Oct. 17, 2005

Related U.S. Application Data
(60) Provisional application No. 60/619,528, filed on Oct. 15, 2004.

(51) Int. Cl. G09B 19/00

(52) U.S. Cl. 434/118

(57) ABSTRACT

An IT equipment simulator for simulating IT equipment includes a housing sized to fit in a standard IT equipment rack, the housing is configured to provide an airflow characteristic substantially equal to the IT equipment under simulation, a variable electric load disposed in the housing, a fan disposed in the housing and configured to produce airflow such that air flows into the housing, absorbs heat from the load, and flows out of the housing, wherein the housing is substantially free of further IT equipment.

### CROSS-REFERENCE TO RELATED ACTIONS

This application claims the benefit of U.S. Provisional Application No. 60/619,528 filed Oct. 15, 2004 and is incorporated by reference herein.

### BACKGROUND

Data centers and computer rooms are designed to power and cool a desired amount of equipment, and are often built with expansion in mind, allowing space for additional equipment to be added over the lifetime of the facility. Because the full amount of equipment to be installed in the data center is not typically available when the facility is first put in service, however, it is difficult to know whether the room as built/configured actually performs as intended.

Testing the power capabilities of a completed data center, or data center commissioning, is typically performed using high-power portable load banks. The load banks are typically standalone units (i.e., not rack mounted) that are connected directly to a power source (such as an output of an uninterruptible power supply (UPS) or a power distribution unit (PDU)) for testing the adequacy of the data center's power system. The load banks place a load on the power system by using heating elements to convert electrical energy into heat. The heat produced is then carried away from the load banks, either naturally (e.g., convection) or by using fans. Large load banks are often used to minimize the number of units and the set-up time. Due to physical size of the load banks, they may have to remain outside of the data center. Typical load banks use fixed speed fans to move a fixed amount of air to help prevent the load bank's heating elements from overheating at maximum loading. Due to the constant fan speed, at lower load levels the air remains cool (e.g., 10 degrees Fahrenheit above ambient), and at high load levels the air gets extremely hot (e.g., 100 degrees Fahrenheit above ambient). This behavior is unlike actual information technology (“IT”) equipment that is commonly designed to raise the temperature of cooling air by only about 20-35 degrees Fahrenheit. Combined with the common practice of using one physically small load bank to simulate multiple pieces of IT equipment, the resulting heated air is generally much hotter and much more concentrated than that produced by the equivalent IT equipment. The load banks are typically installed wherever floor space and high power connections are available. Thus, load banks create airflow patterns that concentrate the hot air in the general vicinity of each of the load banks.

### SUMMARY

In general, in an aspect, the invention provides an IT equipment simulator for simulating IT equipment, the simulator including a housing sized to fit in a standard IT equipment rack, the housing is configured to provide an airflow characteristic substantially equal to the IT equipment under simulation, a variable electric load disposed in the housing, a fan disposed in the housing and configured to produce airflow such that air flows into the housing, absorbs heat from the load, and flows out of the housing, wherein the housing is substantially free of further IT equipment.

Implementations of the invention may include one or more of the following features. A fan speed is user selectable. The fan is configured to produce airflow such that air flows into the housing through a front of the housing, and flows out a back of the housing. The housing, the variable electric load, and the fan are configured to provide a substantially constant temperature rise of the air flowing out of the housing relative to air flowing in to the housing. The fan is configured to produce a set of discrete rates of airflow. The IT equipment simulator further includes a controller, wherein the controller is configured to adjust a volume of airflow produced by the fan. The IT equipment simulator further includes a sensor, wherein the controller is configured to adjust the volume of airflow produced by the fan in response to data received from the sensor. The sensor is configured to measure at least one of airflow speed, airflow volume, inlet temperature, exhaust temperature, input voltage, input frequency, current draw, power draw, temperature rise, and power factor.

Also, implementations of the invention may include one or more of the following features. The IT equipment simulator further includes a controller coupled to the load, the controller is configured to alter the power consumed by the load. The IT equipment simulator further includes a controller and a temperature sensor, wherein the controller is configured to control, in response to information received from the sensor, power consumed by the load. The IT equipment simulator further includes a controller, a sensor, and a communication port, the sensor being configured to transmit information via the communication port, the load being configured to vary in response to information received from the communication port. The IT equipment simulator further includes a sensor and a communication port coupled to the sensor and the fan, the sensor being configured to transmit data via the communication port, the fan being configured to vary speed in response to information received from the communication port. The communication port is an Ethernet port. The IT equipment simulator further includes a controller and a memory that includes load and airflow setting information. The memory contains operational profiles of the simulated IT equipment. The controller is configured to set an airflow based on a selected one of the operational profiles. The controller is configured to provide a power consumption value to the load based on a selected one of the operational profiles. The controller is configured to implement a fan control algorithm based on a selected one of the operational profiles.

Also, implementations of the invention may include one or more of the following features. The IT equipment simulator further includes a controller disposed within the housing. The IT equipment simulator further includes a sensor. The IT equipment simulator further includes a controller and a communication port, the controller being coupled to the communication port, wherein the controller controls operating characteristics of the IT equipment simulator in response to data received by the communication port. The IT equipment simulator further includes a controller and a communication port, the controller being coupled to the communication port, wherein the fan is coupled to the controller and the controller is configured to adjust a volume of airflow produced by the fan in response to data received by the communication port. The IT equipment simulator further includes a controller and a communication port, the controller being coupled to the communication port, wherein the controller is configured to control a power factor of the IT equipment simulator in response to data received by the communication port. The variable electric load is a resistive heater. The variable electric load is configured to vary in discrete incremental steps. A height of the housing is substantially one of: 2 rack units (U), 7U, and 10U. The housing is substantially similar to a housing of the simulated IT equipment. The IT equipment simulator further includes a simulated network connector. The IT equipment simulator further includes: a first network port; a second network port; and a network bypass relay connected to the first network port and the second network port, the network bypass relay being configured to communicate a network signal from the first network port to the second network port when the IT equipment simulator is non-functional. The IT equipment simulator is configured to substantially conform to the IEC-61010-1:2001 safety standard. The IT equipment simulator is configured to provide a substantially uniform exhaust airflow pattern over an exhaust port provided by the housing. The IT equipment simulator is configured to provide a substantially uniform temperature difference between air flowing into the housing and air flowing out of the housing.

In general, in another aspect, the invention provides an IT equipment simulator for simulating at least one piece of IT equipment, the simulator including a housing sized to fit in a standard IT equipment rack, the housing is configured to provide an airflow characteristic substantially equal to the IT equipment under simulation, a removable modular variable electric load, a fan disposed in the housing to produce airflow such that air flows into the housing, absorbs heat from the load, and flows out of the housing, a communication input, a controller coupled to the communication input, the fan, and the removable electric load, the controller being configured to adjust a volume of airflow produced by the fan and power consumed by the load, and a memory coupled to the controller, where the housing is substantially free of further IT equipment.

Implementations of the invention may include one or more of the following features. The variable electric load is a resistive heater. The memory contains operational profiles of the IT equipment. The controller is configured to set an airflow based on a selected one of the operational profiles. The controller is configured to provide a power consumption value to the load based on a selected one of the operational profiles. The controller is configured to implement a fan control algorithm based on a selected one of the operational profiles. The IT equipment simulator further includes at least one of a temperature sensor and an airflow sensor, wherein the controller is configured to adjust a volume of airflow provided by the fan as a function of data received from the at least one sensor.

In general, in another aspect, the invention provides a method for simulating an installation of IT equipment in a facility including a power distribution system and a cooling system, the method including providing equipment simulators in at least one equipment rack, the equipment simulators each comprising a housing, a variable electric load, and a variable airflow source, powering the equipment simulators from the power distribution system, inducing a first airflow substantially similar to a second airflow of the IT equipment, inducing a first power consumption substantially similar to a second power consumption of the IT equipment, and analyzing an operational characteristic of the equipment installation.

Implementations of the invention may include one or more of the following features. Inducing the first power consumption comprises regulating the loads using an automatic controller. Inducing the first airflow comprises regulating the airflow source using an automatic controller. The method further includes drawing air in through fronts of the equipment simulators, heating the air to simulate heat produced by the IT equipment when installed in the installation, and exhausting the air through rears of the equipment simulators. The method further includes controlling the equipment simulators using at least one communication port coupled to the equipment simulators. The method further includes configuring the equipment simulators using at least one communication port coupled to the equipment simulators. The method further includes monitoring the equipment simulators using at least one communication port coupled to the equipment simulators. The method further includes connecting at least one cable to at least one of the simulators to simulate a cabling arrangement in the installation.

Various aspects of the invention may provide one or more of the following capabilities. Power dissipation, heat generation, and airflow patterns of electronics equipment, including IT equipment, may be simulated. Power draw of electronics equipment, including IT equipment, may be simulated. Visual appearance of electronics equipment, including IT equipment, may be simulated. The sound (e.g., cooling-related noise from fans) of electronics equipment, including IT equipment, may be simulated. The cabling within an equipment installation may be simulated. Data center power and thermal commissioning may be accomplished without using any actual IT equipment. Simulators can be used in an existing data center to determine if additional IT equipment can be added to the existing infrastructure. End-to-end testing of the data center's power system (e.g., from the main power entrance through the power receptacles in the rack) may be accomplished. End-to-end testing of the data center's cooling system (e.g., from initial cooling, air delivery to the IT equipment, exhaust from the IT equipment, and back to the cooling unit) may be accomplished. Simultaneous testing of the data center's cooling and power delivery system may be accomplished. Increasing the completeness of the results obtained during the data center commissioning process. Increasing the accuracy and completeness of the data center commissioning process, (e.g., more accurate power commissioning results, and more accurate thermal conditioning results), by testing the data center infrastructure from end-to-end. The weight of actual IT equipment may be simulated.

These and other capabilities of the invention, along with the invention itself, will be more fully understood after a review of the following figures, detailed description, and claims.

### BRIEF DESCRIPTIONS OF THE FIGURES

FIG. 1 is a perspective view of a typical data center configuration.

FIG. 2 is a perspective view of a typical equipment rack with IT equipment installed.

FIG. 3 is a front perspective view of an IT equipment simulator.

FIG. 4 is a rear perspective view of the IT equipment simulator shown in FIG. 3.

FIG. 5 is a front perspective view of the IT equipment simulator shown in FIG. 3 with a top cover and bezels removed.

FIG. 6 is a rear perspective view of the IT equipment simulator shown in FIG. 3 with the top cover and bezels removed.

FIG. 7 is an exemplary airflow pattern diagram of an IT equipment simulator viewed from above the IT equipment simulator.

FIG. 8 is an exemplary temperature contour diagram of an IT equipment simulator viewed from behind the IT equipment simulator.

FIG. 9 is an exemplary temperature contour diagram of an IT equipment simulator viewed from above the IT equipment simulator.

FIG. 10 is a block diagram of a control portion of the IT equipment simulator.

FIG. 11 is a front view diagram of an exemplary control panel for use as part of an IT equipment simulator.

FIG. 12 is a front view diagram of another exemplary control panel for use as part of an IT equipment simulator.

FIG. 13 is a front view diagram of another exemplary control panel for use as part of an IT equipment simulator.

FIG. 14 is a front view diagram of another exemplary control panel for use as part of an IT equipment simulator.

FIG. 15 is a front view diagram of another exemplary control panel for use as part of an IT equipment simulator.

FIG. 16 is a front view diagram of another exemplary control panel for use as part of an IT equipment simulator.

FIG. 17 is a flow chart of a process of automatic fan speed control for use in IT equipment simulation.

FIG. 18 is a flow chart of a process of automatic fan speed and heat control for use in IT equipment simulation.

FIG. 19 is a diagram of a remote connection between a rack-mounted IT equipment simulator and a computer.

FIG. 20 is a perspective diagram of a “blade” IT equipment simulator.

FIG. 21 is a flow chart of an exemplary IT equipment simulation procedure.

### DETAILED DESCRIPTION

The disclosure describes an IT equipment simulator apparatus that realistically simulates the presence of internet technology (IT) equipment, e.g., for use in testing a power delivery system and cooling capabilities of a data center or a laboratory, etc. The apparatus simulates actual IT equipment by providing a form factor that mimics actual IT equipment, providing variable power consumption, and providing variable airflow from a front of the simulator to the back of the simulator. Using multiple apparatus, or a single apparatus with a shape similar to multiple IT equipment pieces, heat can be distributed in a rack, a room, and/or a row in a manner similar to an equivalent set of actual IT equipment. The simulator is placed in the same location that the simulated equipment will occupy (e.g., in the rack). For example, a 10U apparatus can be configured to provide a power consumption and temperature increase similar to that of ten 1U network apparatus. The apparatus can also simulate more or fewer rack units of equipment than the apparatus occupies (e.g., a 10U simulator can simulate 30U worth of IT equipment, or a 10U simulator may simulate 2U with of IT equipment). The apparatus simulates the heat created by actual IT equipment using one or more heaters and one or more fans to exhaust the heated air produced by the heater(s). The apparatus can be used to determine if a data center cooling system is adequate by stressing the cooling system in an end-to-end manner just as actual IT equipment does. Furthermore, the apparatus draws from the power distribution system an amount of current and power equivalent to that drawn by the simulated actual IT equipment, thus testing a data center power delivery system from end-to-end.

The apparatus can be used in place of actual IT equipment during the data center commissioning process to simulate the power and thermal operating characteristics of actual IT equipment, increase the accuracy of the power and thermal testing process (by testing the power delivery and cooling systems end-to-end), and/or improve the thoroughness of the simulation (e.g., end-to-end simulation of the data center). For example, one or more simulator apparatus are installed into each networking rack of the data center depending on the type, quantity, location, and/or load requirements of the simulated actual IT equipment. The apparatus can be switched on and off to achieve a desired operating condition. An operator may control the airflow and/or electrical load, e.g., via switches, a knob, a remote connection, or other means. Data are collected either manually (e.g., walking around the room with a thermometer), or using sensors (e.g., sensors in the simulator, data center, and/or cooling system) to determine the performance of the power distribution and/or cooling systems. This process may be repeated to test different scenarios such as different room layouts, different power levels, different airflow levels/patterns, power and cooling system failure, different ambient temperatures, etc. Possible uses of the apparatus include data center commissioning, full-up system testing, laboratory work, use at tradeshows and demonstration centers for advertising, and/or validation studies to verify power and cooling solutions prior to purchasing high-density equipment (e.g., 1U servers, blade servers, etc.).

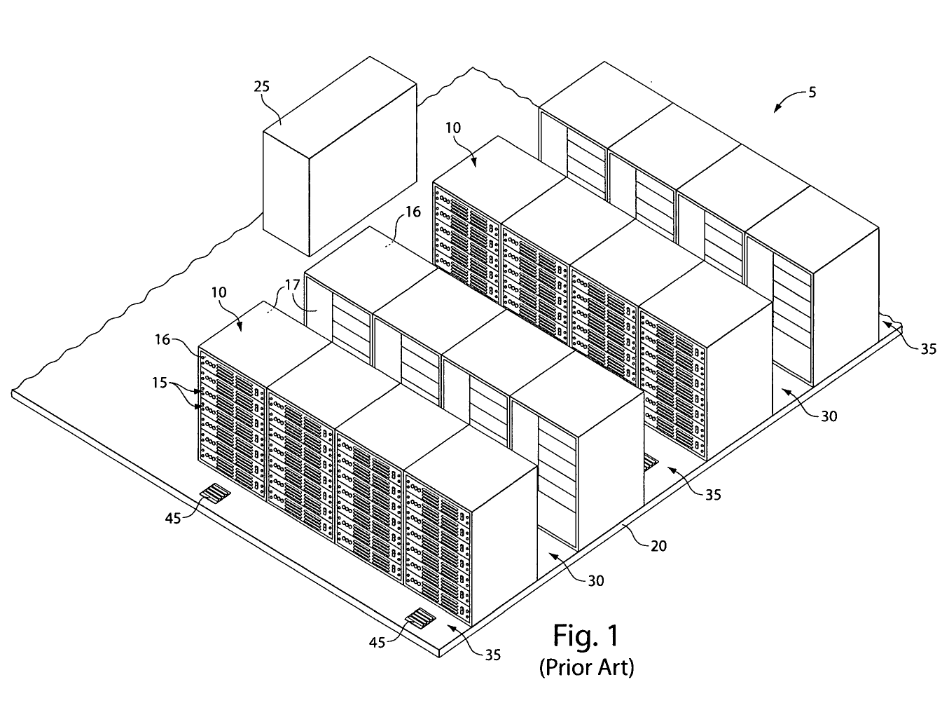

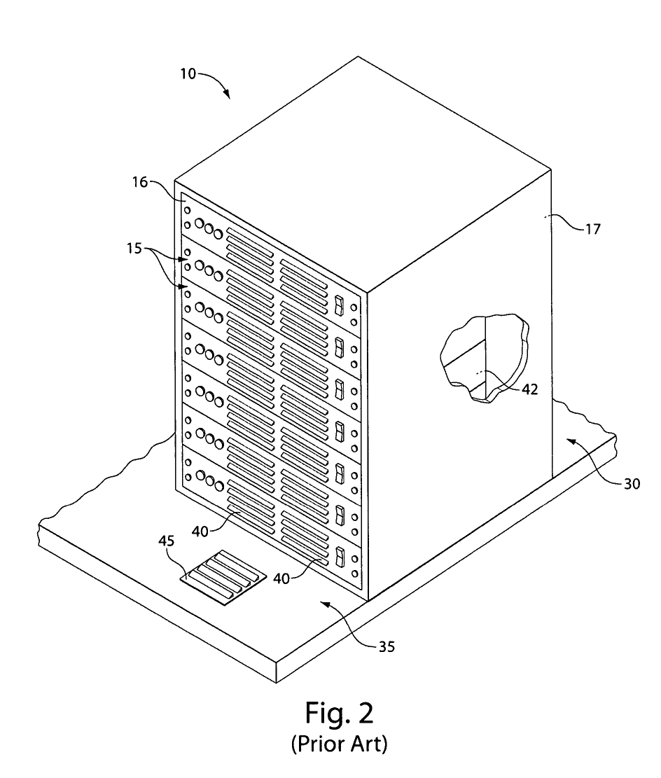

Referring to FIGS. 1 and 2, a data center 5 includes several equipment racks 10, several pieces of equipment 15, a flooring system 20, and a cooling system 25. The equipment 15 is installed in the equipment racks 10 such that “hot aisles” 30 and “cold aisles” 35 are created. The hot aisles 30 and cold aisles 35 are created because the equipment 15 draws cold air in via vents 40 disposed on fronts of the equipment 15, near fronts 16 of the racks 10 and exhausts heated air out rears 42 of the equipment 15 and out backs 17 of the racks 10. The flooring system 20 includes cold-air vents 45 in the floor at the bottom of the cold aisles 35 through which cold air from the cooling system 25 is provided. The equipment racks 10 are standard equipment racks (e.g., 19″ wide and 1.75″ per equipment mounting position (U)) and contain 42 equipment positions (e.g., a 42U rack), although other sizes and/or configurations are possible. While the data center 5 includes a flooring system 20 and a cooling system 25, these components are not required. The data center 5 shown is exemplary and not limiting of the invention.

A 208V/60 Hz power connection (not shown) is provided to each of the equipment racks 10. The power connection provides power to the equipment 15 and possibly to the equipment rack 10 itself (e.g., a “smart” rack). Other voltages and/or configurations of power connections may be used such as 230V/50 Hz or 3-phase connections. Furthermore, various transformers, multiple feeds, uninterruptible power supplies (UPSs), batteries, etc. may be used to provide power to the equipment racks 10.

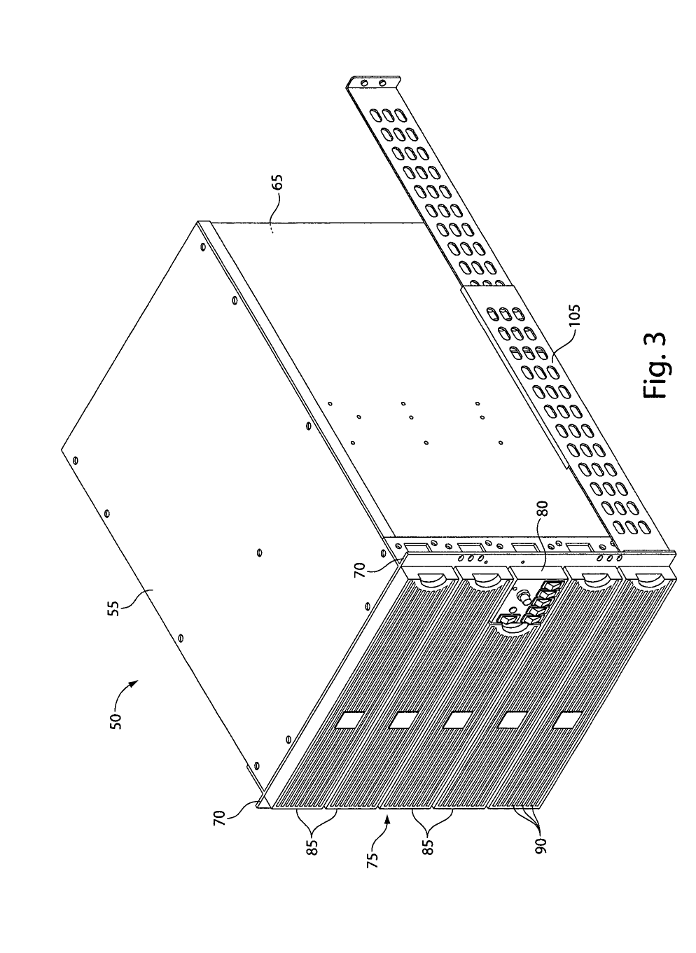

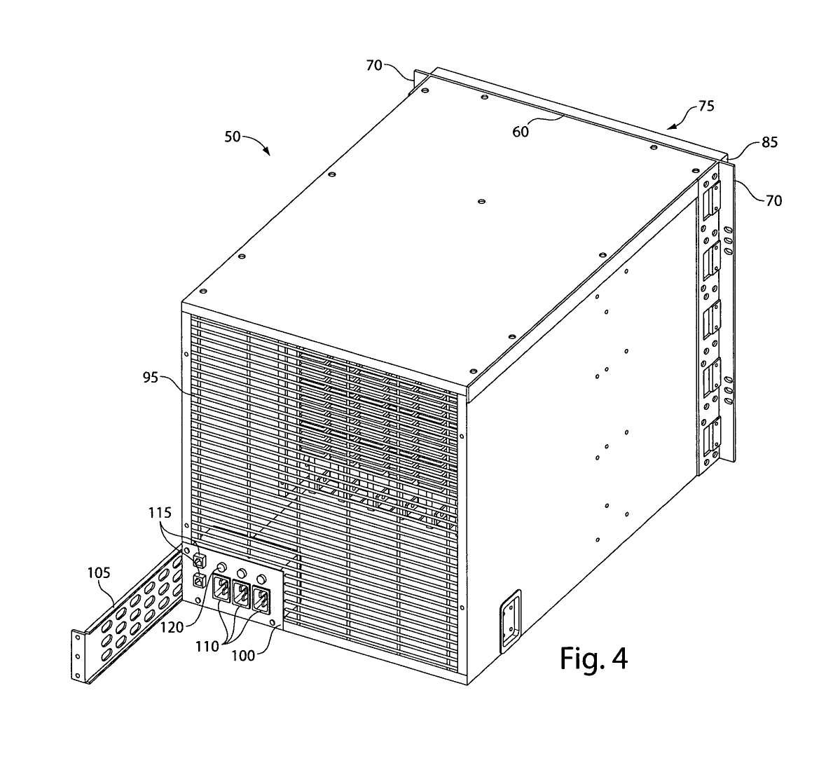

Referring to FIGS. 3 and 4, a 10U IT equipment simulator 50 including a housing 55, a front panel 75, a control panel 80, a rear grill 95, a rail kit 105, and an input panel 100 is provided. The housing 55 includes a front 60, a back 65, and rack ears 70. While a 10U version of the simulator 50 is shown, other simulator configurations are possible such as a 1U, 5U, or 7U “blade” device.

Attached to the front 60 of the housing 55 is a front panel 75. The front panel 75 comprises 5 separate 2U modular bezels 85, although other sizes and/or combinations of bezels are possible (e.g., one continuous 10U-high front bezel, two 5U-high front bezels, etc.). The front panel 75 is preferably removable and includes an air filter (not shown). The front panel 75 includes a series of vents 90 (e.g., open slits) to allow air to flow through the front panel 75 without substantially impeding the air.

The modular bezels 85 are preferably configured to resemble the type of equipment being simulated. For example, the modular bezels 85 may include simulated non-functional switches, knobs, indicators (e.g., flashing lights), artificial panels, and/or vent holes placed similar to that of a simulated device. In this respect, the simulator 50 has a cosmetic appearance (e.g., plastic bezels) similar to fully functional IT equipment, and thus simulates data center equipment with respect to airflow and visual appearance. Visual simulation of a fully functional equipment rack may be useful, e.g., at trade shows and demonstrations.

Attached to the back 65 of housing 55 is the rear grill 95 and the input panel 100. The rear grill 95 is configured to not substantially impede airflow through the housing 55, yet inhibit external objects or human body parts from entering the housing 55. Other configurations of the grill 95 are possible (e.g., the rear grill 95 may be identical to the front panel 75). Ambient air is drawn in the front panel 75, heated, and exhausted out of the rear grill 95. The input panel 100 is positioned to reduce the impact on the airflow within the simulator 50, and includes communication connectors, power connectors and/or indicators used in operating the simulator 50, as discussed more fully below.

The simulator 50 may be mounted directly to the equipment rack 10 using the rack ears 70, and/or the rail kit 105 (such as a Smart-UPS® rail kit (Part No. 0M-756F) manufactured by American Power Conversion, Corp., of West Kingston, Rhode Island). The simulator 50 can be mounted to the rack 10 using the rail kit 105 and the rack can be shipped with the simulator 50 installed.

The input panel 100 includes power connections 110, network connectors 115, and status lights 120 that correspond to each of the power connections 110. While three power connections 110, two network connections 115, and three status lights 120 are shown, other quantities and types of these items may be used (e.g., no network connection). The network connectors 115 are RJ-45 connectors that provide termination points for Ethernet cables (not shown), although other connector/cable combinations are possible. For example, a network card slot (not shown) that is adapted to receive a networking card (such as a UPS network management card (Model No. AP9617) manufactured by APC Corporation of West Kingston, Rhode Island), or a gigabit-interface converter (GBIC) may be used. The network connectors 115 may be active (e.g., providing network service to the simulator 50) or may be non-functional connectors. Several non-functional versions of the network connectors 115 may be used to simulate the wiring present when functional IT equipment, such as a server, is installed in the equipment rack 10. Simulation of the cabling in an operational configuration of the data center 5 is useful to determine how the wiring of the equipment rack 10, when loaded with IT equipment, will affect the airflow within the equipment rack 10, and thus, the cooling efficiency within the data center 5. Simulated cabling is also useful for demonstration purposes at trade shows and in advertisements.

The power connections 110 are the primary inputs for power to the simulator 50, and are configured to connect to the same type of power supply as the networking equipment being simulated. For example, if the simulator 50 simulates standard 1U servers, then power connections 110 are configured to accept 208V/60 Hz power feeds, although other configurations, frequencies, phases, and/or voltages are possible (including DC feeds). As shown in FIG. 4, the power connections 110 are IEC-60320-C20 receptacles, though other receptacles and/or cables are possible (e.g., a hardwired power cord(s), IEC-60320-C14, NEMA 5-15, etc.). Each of the power connections 110 shown in FIG. 4 may be active (for example, each of the power connections 110 may draw 2 kW from separate circuits) or may be non-functional and/or cosmetic connectors.

The status lights 120 are neon indicators (although other types of indicators may be used such as LEDs) that change color and/or state (e.g., between solid and flashing) as a function of the status of the corresponding power connection 110. For example if there is no power being supplied to the corresponding power connection 110, then the status light 120 does not illuminate, or if power is being supplied to the corresponding power connection 110, the status light 120 illuminates. The status lights 120 may also indicate a fault condition, such as low-voltage, by e.g., repetitively flashing.

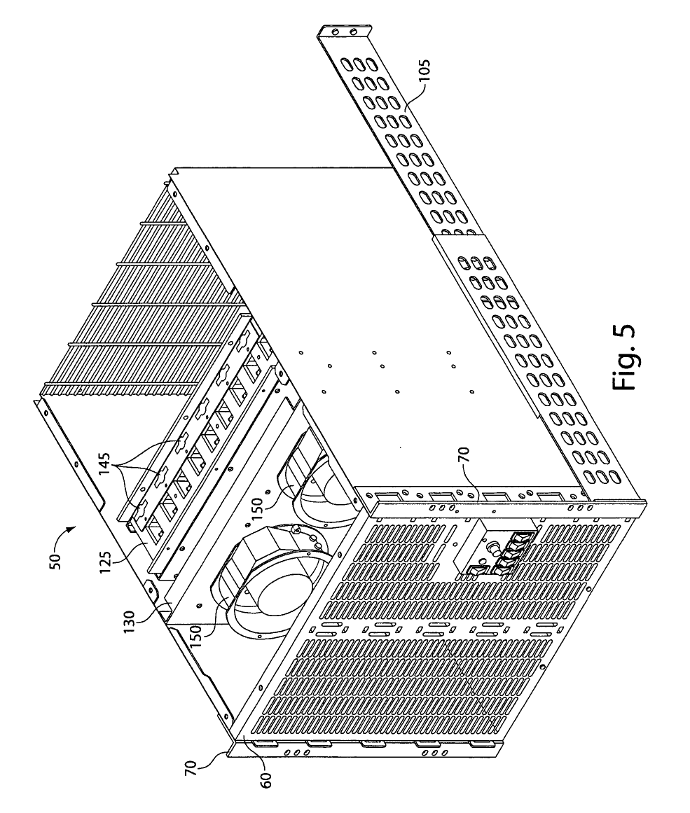

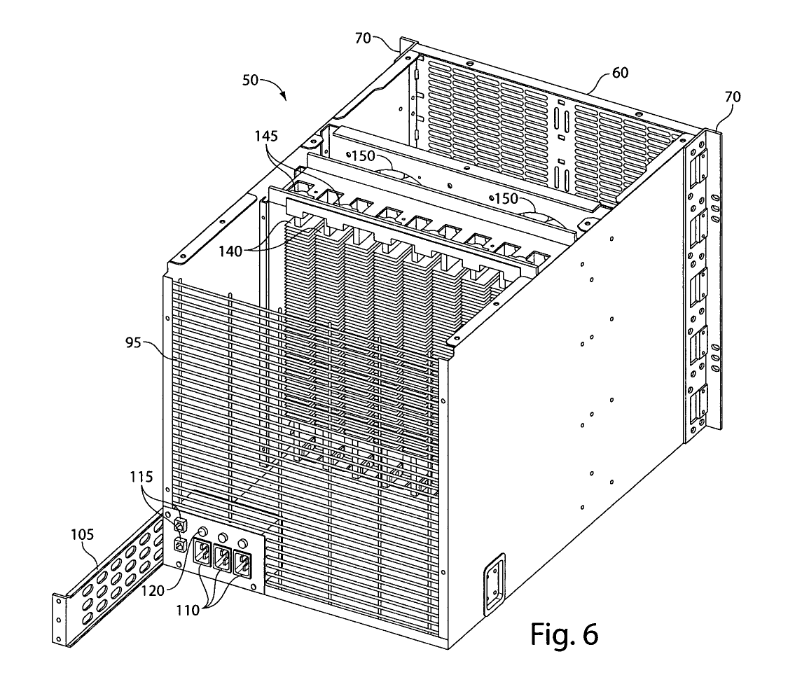

Referring to FIGS. 5 and 6, the simulator 50 includes a heating unit 125 and a fan unit 130. The fan unit 130 is disposed between the heating unit 125 and the front 60 of the housing 55. While the fan unit 130 is shown being located between the heating unit 125 and the front 60, other configurations are possible. For example, the fan unit 130 may be located between the heating portion and the back 65, thus drawing air through the heating unit 125 prior to reaching the fan unit 130. The fan unit 130 includes four fans 150 disposed in a 2×2 configuration. The fans 150 are configured to draw air in through the front 60 (via the front panel 75), blow it through the heating unit 125, and exhaust the air through the back 65.

The heating unit 125 includes heating elements 140, and thermal switches 145. The heating elements 140 consist of three 1 kW heaters, five 500 W heaters, and one 250 W heater. Although, other elements with other power capacities may be used (e.g., 6×500 W, 3×1500 W, 250 W, etc.). Also, while eight heating elements 140 are shown, other quantities of heating elements may be used. The heating elements 140 are electrically insulated finned strip resistive heaters, though other heat sources are possible (e.g., resistive coils, power resistors, nichrome wire, solid-state heaters, finned tubular heaters, power resistors, etc.).

The thermal switches are self-resetting over-temperature devices designed to help prevent the heating elements from overheating or causing a safety hazard (e.g., starting a fire). The thermal switches provide two functions. First, if the thermal switches 145 reach a predetermined “high” temperature, the thermal switches 145 cause the fan speed to increase (thus increasing airflow volume), thereby reducing the temperature of the air being exhausted from the simulator. Once the temperature is reduced, the fan speed is reduced. Second, if one of the heating elements 140 overheats (by reaching a second predetermined high temperature), the corresponding thermal switch shuts down the heating elements 140, but keeps the fans running to prevent personal injury and/or damage to the data center. Once either of the high-temperature thresholds are reached, the simulator activates a warning light and/or audible warning signal, such as a buzzer or tone.

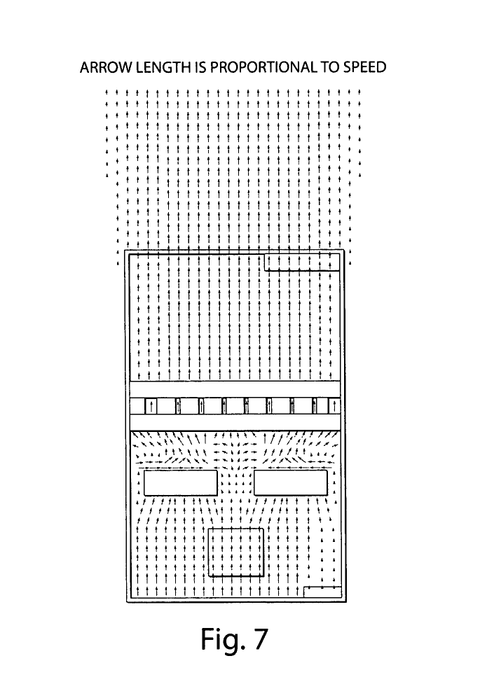

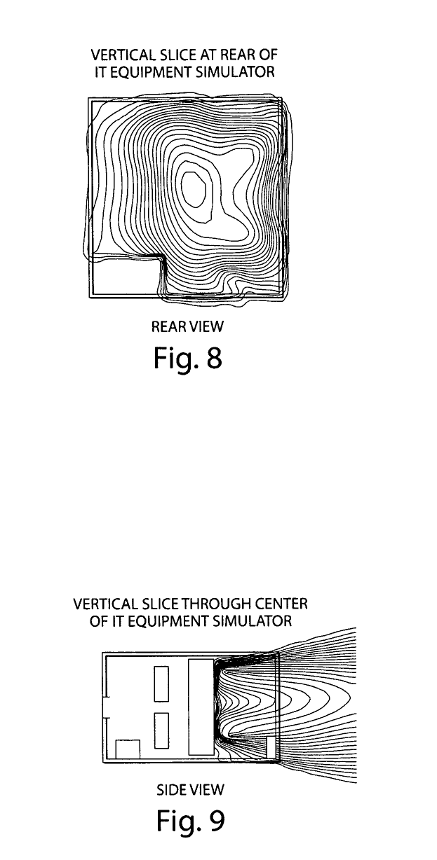

The fan unit 130 includes four fans 150. The fans 150 are 172 mm axial AC fans with electronic speed control, and are arranged in a 2×2 configuration (one of the fans is not visible in FIG. 5, and two of the fans are not visible in FIG. 6), though other sizes and/or configurations of the fans 150 are possible (e.g., blowers, bellows, pistons, compressors, air reservoirs, and/or a single large fan). For example, in a 2U simulator, the fan unit 130 may use a 5×1 configuration of 80 mm fans. Other methods of air control exist, such as dampers, doors, and/or variable length exhaust paths. The fans 150 may provide a fixed airflow, be user-adjustable, or be automatically controlled by the simulator 50 (as is described in detail below). The fans 150 may be tuned and calibrated to match vent and temperature patterns such as those shown in FIGS. 7-9. Also, DC fans may be used.

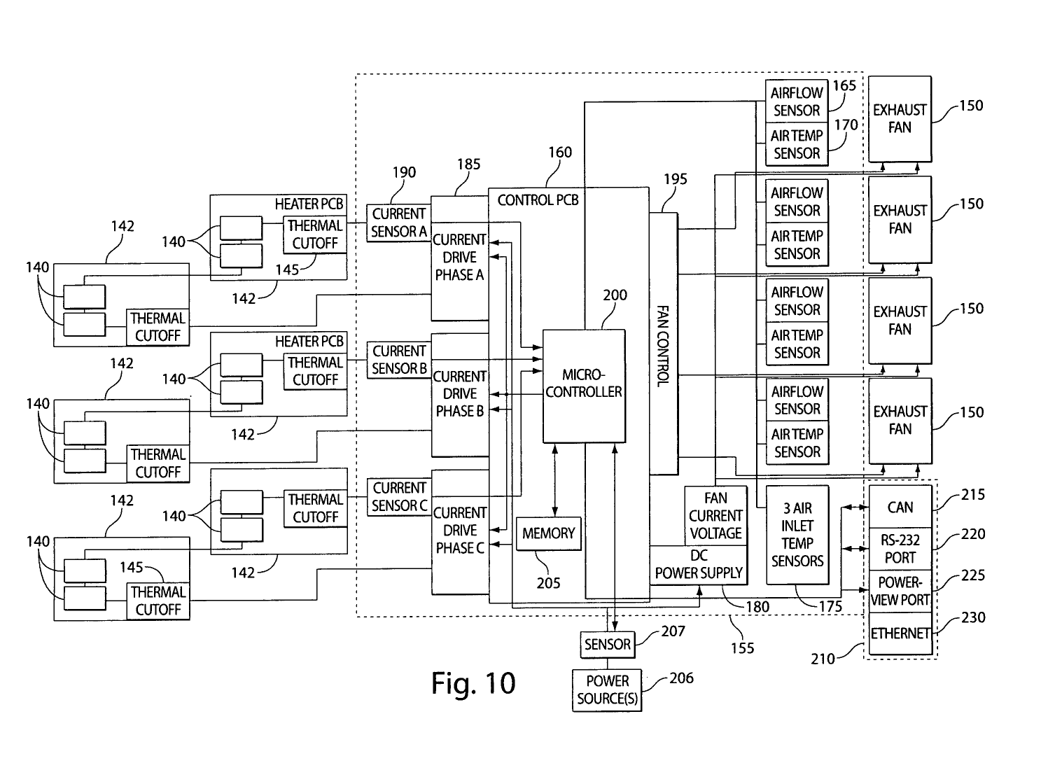

Referring to FIG. 10, an exemplary control portion 155 that provides internal command, control, and feedback is shown. The control portion 155 contains heater, a control printed circuit board (PCB) 160, several airflow sensors 165, several exhaust temperature sensors 170, several inlet temperature sensors 175, a DC power supply 180, several current drivers 185, current sensors 190, and a fan controller 195. The control PCB 160 includes a microcontroller 200 and a memory 205. The microcontroller 200 is connected to the heating elements 140, the airflow sensors 165, the air temperature sensors 170, and the fan controller 195. The microcontroller 200 is a Phillips PXAG49 KBA, although other microcontrollers may be used. While the microcontroller 200 has been described as including control functions, other configurations exist (e.g., the microcontroller 200 may provide only communication functions). The microcontroller 200 monitors the temperature differential between the air being drawn into the simulator and the air being exhausted out the back 65 of the simulator 50, as indicated by the inlet temperature sensors 175, and the exhaust temperature sensors 170, respectively, and adjusts the fan speeds and/or heater power levels to obtain a constant exhaust air temperature rise (e.g., the difference in temperature between the incoming air and the exhausted air). The microcontroller 200 also monitors the amount of electrical current and/or power being used by the heating elements 140, as indicated by the current sensors 190, and regulates the current drivers 185 to help ensure a substantially constant desired load is placed on an electrical system under test.

The microcontroller 200 monitors operating characteristics of the power being provided to IT equipment simulators. A power source 206 is monitored by a sensor 207 to determine operating characteristics such as input voltage, input frequency, power draw, temperature rise, current draw, power draw, power factor, etc.

The microcontroller 200 operates in accordance with instructions stored in the memory 205 (or an internal memory contained within the microcontroller 200). The memory 205 is standard RAM, or other storage medium (e.g., Flash ROM, hard drive, tape, CD-ROM, etc.), and provides operational memory to the microcontroller 200. The memory 205 stores software code and/or data that the controller 200 reads while executing a testing routine. The memory 205 preferably stores results of prior tests, including testing events (e.g., brownouts, blackouts, over-temperature alerts, etc). The memory 205 also contains profiles of common networking equipment (e.g., a volume of air produced by a specific piece of IT equipment, power consumed by a specific piece of IT equipment, and/or fan control algorithms). The operator, via a remote connection (as described more fully below) can pick a specific piece of equipment to simulate, rather than manually setting the heat levels and fan speeds. For example, the operator can use the simulator 50 to simulate five Dell® PowerEdge™ 2850 servers by having the microcontroller 200 retrieve the profile of a Dell® PowerEdge™ 2850 server from the memory 205, and set the fan speed and/or heating intensity accordingly to simulate five such units. Furthermore, the microcontroller 200 can simulate fan control algorithms found in specific pieces IT equipment under simulation. For example, some IT equipment includes a fan control algorithm that adjusts the fan speed depending on the computational load of the IT equipment (e.g., higher activity levels in a server causes more heat, and in turn, higher fan speeds). Thus, the operator can choose a lightly loaded piece of IT equipment, or a heavily loaded piece of IT equipment, or some combination thereof (e.g., a simulation program that varies the simulated load and airflow).

The control portion 155 is further connected to a communication portion 210. The communication portion 210 includes a controller area network (CAN) interface 215, an RS-232 port 220, a local display port 225, and an Ethernet connection 230, although other combinations and/or protocols are possible, such as RS-485 and/or Wi-Fi (e.g., 802.11). Each of the CAN interface 215, the RS-232 port 220, the local display port 225 (e.g., a PowerView port), and Ethernet connection 230 are configured to be connected to a corresponding one of the network connectors 115, that uses the appropriate connector type (e.g., RJ-45, RJ-11, DB-9, etc.). The communication portion 210 provides the simulator 50 with a means of communication with another simulator 50, external software (as described more fully below), or an external control. For example, the CAN interface 215 provides for unit-to-unit communication between several of the simulators 50, such as in a master/slave configuration. Notwithstanding the above, the communication portion 210 may use any communication protocol, such as Modbus, SNMP, HTTP/HTML, XML, Telnet, SSH, proprietary, etc.

In embodiments of IT simulators including an Ethernet connection 230, the Ethernet connection 230 may be any speed such as 10 Mbps or 100 Mbps, and include an Ethernet switch. The Ethernet switch provides Ethernet switching capability with short cables interconnecting multiple ones of the simulators 50. The Ethernet connection 230 also includes a relay bypass providing network connectivity through an unpowered or non-functional simulator 50. Thus, when the simulator is functional, the Ethernet connection 230 functions as a switch, and when the simulator is non-functional, Ethernet signals are routed directly to/from other Ethernet devices.

The simulator 50 is controllable via several different methods including manual control using the control panel 80, manual control using the communication portion 210, automatic control using the control panel 80, and/or automatic control via the communication portion 210.

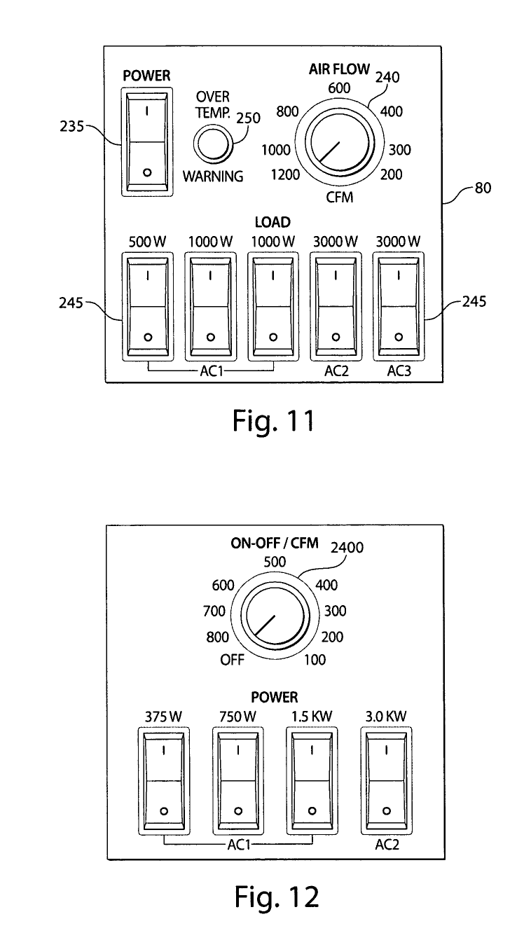

Referring to FIG. 11, the control panel 80 includes a power switch 235, an airflow control knob 240, several load control switches 245, and an over temperature warning light 250. The power switch 235 is a typical rocker switch that controls power to the simulator 50, including the heating unit 125, the fan unit 130, and the control portion 155, although other switch types are possible (e.g., push button, touch pad, etc.). Further, a control panel without a dedicated power switch may be used, e.g., as shown in FIG. 12, where an airflow control knob 2400 includes an “off” position that powers off the simulator 50.

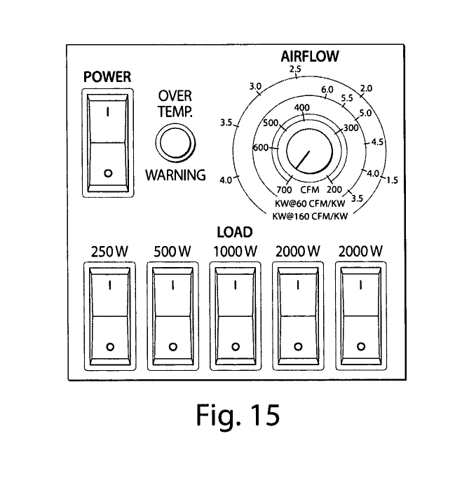

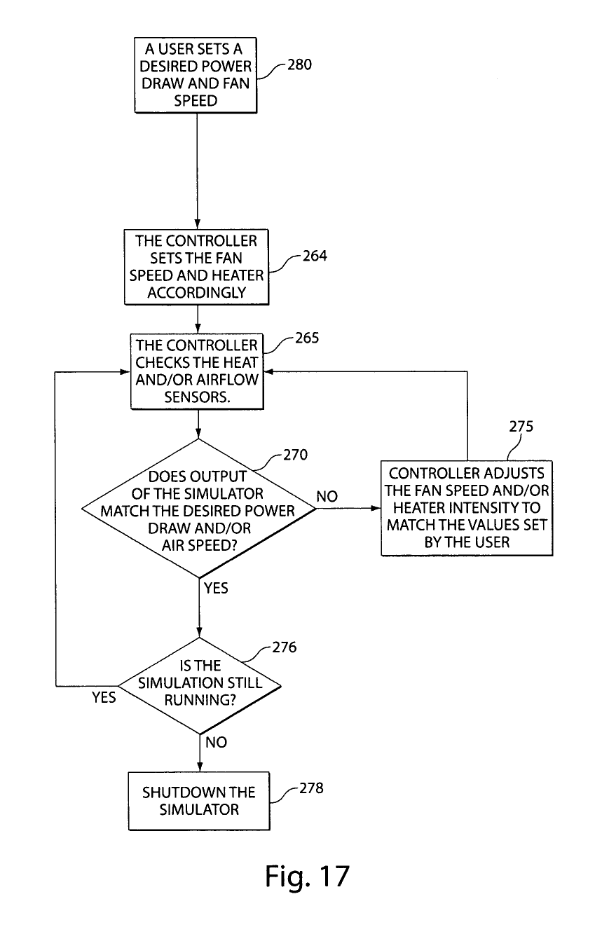

Referring again to FIG. 11, the airflow control knob 240 is an infinitely variable control knob that controls the fans 150, although other embodiments are possible, e.g., an incremental flow control knob is possible (e.g., 250 W steps). The airflow control knob 240 controls the fans 150 via the fan controller 195 as shown in FIG. 10, or may be connected directly to the fans 150. The airflow control knob includes cubic-feet-per-minute markings (CFM), but other markings are possible (e.g., as shown in FIG. 15 a control portion may include CFM per kW (or the metric equivalent)). The microcontroller 200 actuates the flow controller 195 to regulate the speed of the fans 150 to ensure a constant speed. For example, if the operator sets a desired CFM rate of 1000 CFM and the airflow sensors 165 detect a drop in the CFM being produced by the fans 150 (e.g., a reduction caused by a partially blocked airflow), the microcontroller 200 will increase the speed of the fans 150 via the fan controller 195. This is accomplished using the process shown in FIG. 17. In block 280, a user sets a desired power draw and fan speed. In block 264, the controller 200 sets the fan speed and heater accordingly. In blocks 265, 270, and 275, respectively, the controller monitors the outputs of the sensors, compares the returned values to the value set by the operator in block 280, and adjusts the power draw and/or fan speed to ensure that a substantially constant electrical load, heat load, and/or volume airflow is produced. If it is determined in block 276 that the simulation is still running, then flow returns to block 265, and otherwise the simulator is shut down at block 278.

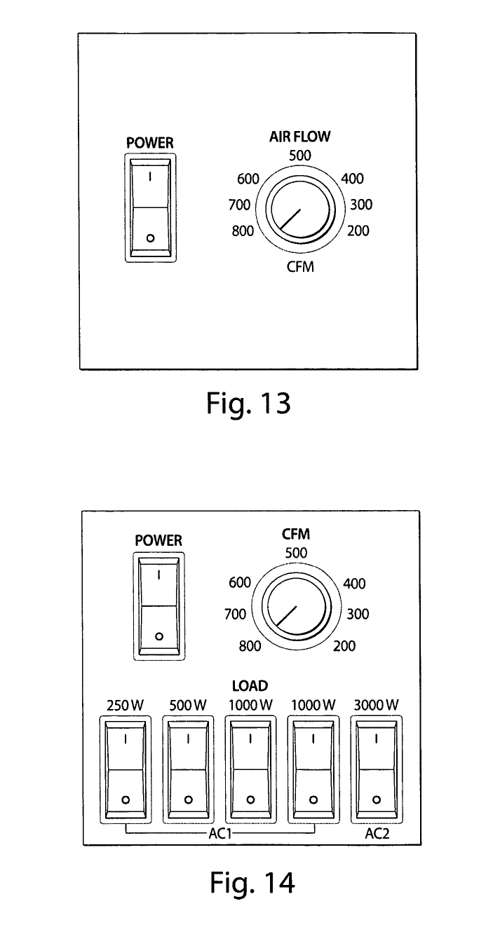

The load control switches 245 are rocker switches that control power to the heating elements 140. The load control switches 245 provide, here incremental (e.g., 250 W steps), control over the amount of electricity consumed (and as a result, heat produced) by the heating elements 140, although an infinitely variable load control switch is possible. In a simulator without the heating element 140, (e.g., a demo unit) the load control switches 245 may be omitted (as shown in FIG. 13), or may be non-functional mock switches. Furthermore, other configurations of the load control switches include a number keypad combined with a digital readout, other knobs, and/or switches.

The over temperature warning light 250 is a neon indicator (although other light sources are possible such as an LED) that illuminates or changes color when any one of the thermal switches 145 activate, indicating an over-temperature condition. As shown in FIGS. 12-14, the over temperature warning light 250 is optional.

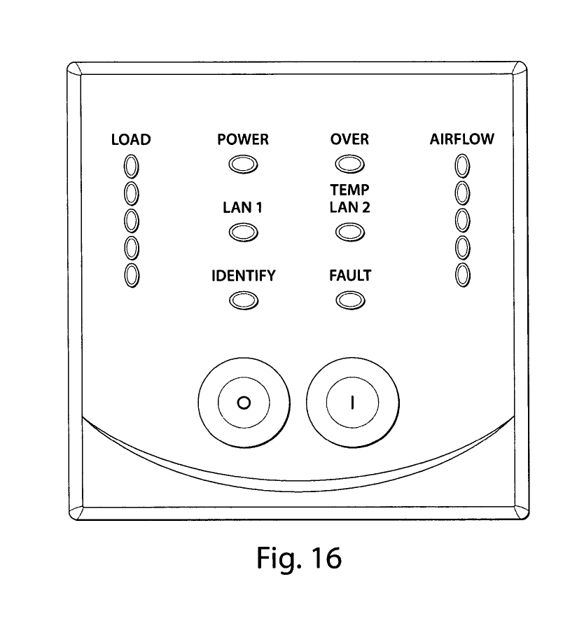

Other embodiments are within the scope of the invention. While the control panel 80 has been described above, other embodiments of control panels are possible. For example, a control panel may include a buzzer to indicate a thermal overload, an LED readout, a keypad, etc. A control panel may use a single LCD touch-screen to control all of the functionality of the simulator 50. The increments of the load control switches 245 may be different from that described above. Multiple airflow control switches 245 may be provided, each corresponding to a different fan 150. A control panel may contain only a power switch when used with an external controller (e.g., as shown in FIG. 16).

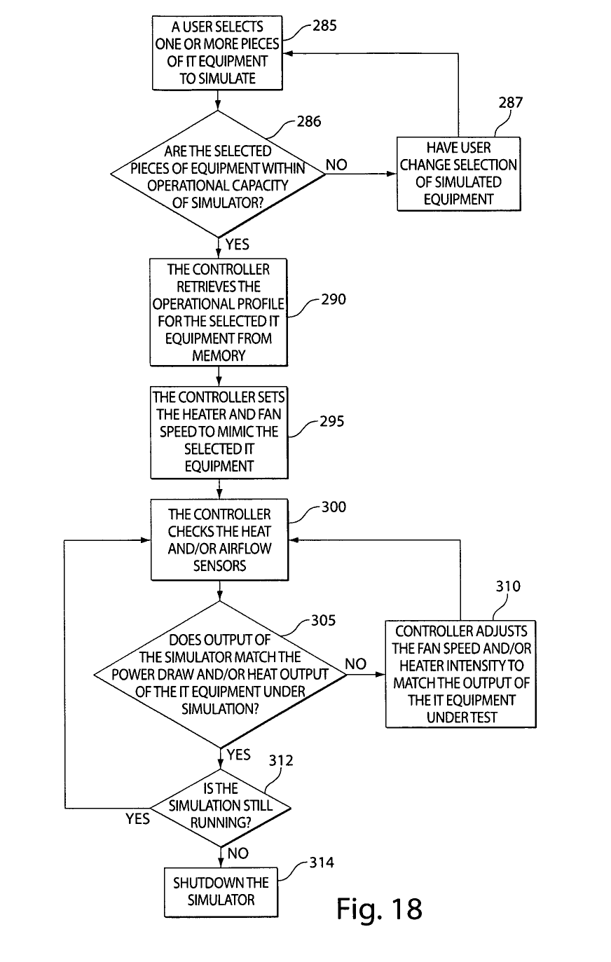

As shown in FIG. 18, a user may choose specific pieces and quantities of equipment to simulate, such as five Dell® PowerEdge™ 2850 servers (including combinations of different types of equipment and/or manufacturers). In block 285, the user selects specific pieces of equipment to simulate. The simulator verifies that the combined heat output, power draw, and current draw are within the operational characteristics of the simulator in block 286, and if not, rejects the configuration and has the user change the selection of simulated equipment in block 287. The controller retrieves the operational profiles of the selected pieces of equipment from memory in block 290. The controller sets the heater and/or fan speed to simulate the combined heat output, current draw, and/or power draw of the selected pieces of equipment in block 295. In blocks 300, 305, 310, respectively, the controller monitors the heat and/or airflow sensors to ensure that the power draw and/or heat produced by the IT equipment simulator is substantially similar to that produced by the selected pieces of simulated equipment, and adjusts the fan speed and/or heater intensity accordingly. If it is determined at block 312 that the simulation is still running, then flow returns to the block 300, and otherwise the simulator is shut down at block 314.

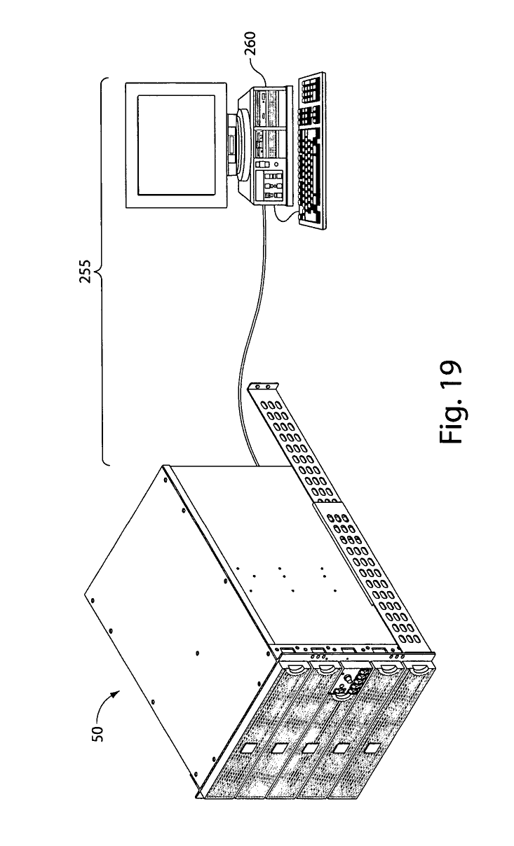

Embodiments of IT equipment simulators may be controlled using the communication portion 210 via an Ethernet connection (or any of the other services provided by the communication portion 210). Referring to FIG. 19, via a remote connection/controller 255, an operator can monitor real-time operational data (e.g., air flow rate, exhaust air temperature, system current per phase, system per phase voltage, inlet air temperature, heater current, air flow setting, heat load setting, etc.) and control the simulator 50, via a remote access device 260.

Several methods exist to implement the remote connection/controller 255. An embodiment of the remote connection/controller 255 includes using a visual basic interface that provides IP address assignment, discovery, and control of power and airflow. Using a visual basic interface the operator can discover loads on the network (e.g., detecting IT equipment simulators attached to the network), display an aggregated tabular status view of the detected loads, and/or control individual loads, arbitrary load groupings, or all loads simultaneously. An HTML (Web-based) interface of remote connection/controller 255 is possible. The operator may access the HTML user interface using any typical Web-browser, such as Netscape® Navigator®, or Microsoft® Internet Explorer. Using an HTML user interface, the operator can turn individual simulators on or off, set load points, identify all of the simulators connected, identify a particular simulator installed in a rack (e.g., by activating an LED on a selected one of the simulators), control fan speed, monitor air inlet temperature, etc. The simulator may contain a web-server that provides individualized load control. A PowerView® embodiment of remote connection/controller 255 can work with a PowerView® handheld control unit (manufactured by APC Corporation of West Kingston, Rhode Island). A PowerView® control unit is a compact control panel and display that provides controlling, monitoring, and configuring a connected device. The PowerView® control unit is connected directly to the simulator through a single interface cable (such as an Ethernet cable).

The remote connection/controller 255 may be used to provide automatic, real-time control of the heating unit 125, and the fan unit 130. For example, the remote connection/controller 255 via external software may monitor the airflow sensors 165, the exhaust temperature sensors 170, and/or the current sensor 190 and use this information to maintain a constant CFM or fan speed, a constant CFM/kW ratio, and/or a constant temperature rise, etc. The remote connection/controller 255 may control a single simulator, (e.g., a one-to-one ratio), or may control multiple simulators.

The remote connection/controller 255 may include an operational profile of the data center such as the number, location, and model of servers, racks, and/or cooling units. Using this information, the remote connection/controller 255 may automatically control the simulation, by emulating varying server loads, and the interaction between individual pieces of IT equipment (e.g., due to the proximity of several pieces of IT equipment, one piece of IT equipment may draw in air exhausted by another piece of IT equipment, rather than cooler, ambient air).

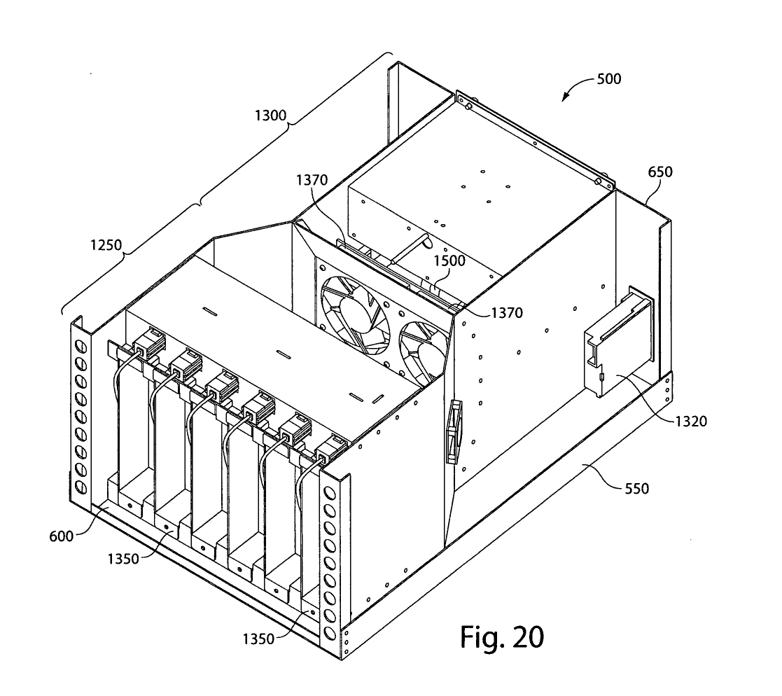

Referring to FIG. 20, a 7U “blade” IT equipment simulator 500 provides the features and functionality similar to that of the simulator 50. The simulator 500 further includes a heating unit 1250, a fan unit 1300, and a network interface card slot 1320. The heating unit 1250 includes several heater blades 1350. Each of the heater blades 1350 contains several heating elements (not shown) and a thermal switch (not shown) as described above in reference to the heating element 140. The blades 1350 are removable, and may have different load capacities (e.g., a blade may contain a 500 W, 1000 W, or 1250 W load). The fan unit 1300 contains anemometers 1370, and blowers 1500 that are removable in order to provide different configurations. Different quantities and/or configurations of the heater blades 1350, anemometers 1370, and/or blowers 1500 may be used to simulate different configurations of network equipment. The fan unit 1300 is disposed between the heater unit 1250 and a back 650 of a housing 550. The fan unit 1300 draws air in through a front 600 across the heating unit 1250, and exhausts it out a back 650.

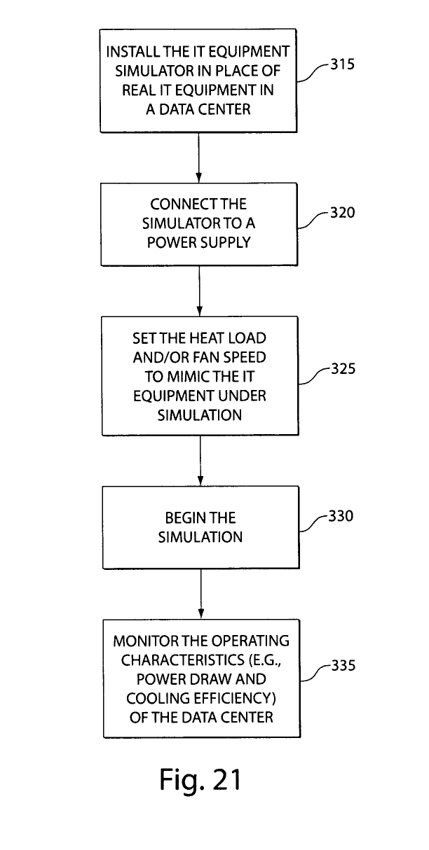

Referring to FIG. 21, an exemplary testing process is described, although other processes exist. In block 315, an operator installs one or more simulators in a rack in manner substantially similar to the way actual IT equipment would be installed. The operator connects the simulator(s) to a power supply in block 320 and sets the power level and/or fan speed in block 325. After the simulation begins in block 330, the operator monitors the power system and/or cooling system to determine operating factors such as efficiency and capacity. Other processes exist, such as switching the simulators on and off during the simulation block 330. FIG. 21 is exemplary only, and not limiting of the invention.

While embodiments of IT equipment simulators disclosed above have focused on cosmetic and functional simulation, simulators can provide audible characteristics similar to that of fully functional IT equipment. Thus, the operator can simulate what a room full of networking equipment will sound like, and determine whether and how to address audible noise considerations that exist, e.g., whether to soundproof the data center 5, or reconfigure the data center 5 using enclosed cabinets.

Embodiments of simulators may also include various sensors. For example, instrumentation such as anemometer fans, temperature probes and/or power factor meters. The sensors may measure quantities such as airflow speed, airflow volume, inlet temperature, exhaust temperature, input voltage, input frequency, current draw, power factor, etc.

Simulators may be adapted to achieve a near-unity power factor (using resistive loads with AC fans and 2×20 W switching power supplies), and approvable by the Underwriters Laboratories (UL) (including the foreign counterparts to the UL). Other simulators may have a 1U high housing using an ATX form factor, or be built using actual IT equipment housings (including power supplies).

Other embodiments of the heating unit 125 exist or may be omitted from simulators (e.g., for use in demonstrations). The heating unit 125 may be configured as a cooling device using water cooling, refrigerant-based cooling, glycol, etc. For example, air may be drawn in from the back 65, passed through the heating unit 125 (functioning as air cooler), and blown out the front 60. Furthermore, the fans 150 may be configured to remain on after the simulator 50 is turned off, e.g., to cool the heating elements 140 to a lower temperature. The fans 150 may produce side-to-side air currents. In demonstration models, simulators may not have heaters, and/or may provide fixed airflow and/or fixed heat levels.

While the microcontroller has been described as the element responsible for automatic control of the heating unit 125 and the fan unit 130, other embodiments may be used (e.g., external software may provide the automatic control). Simulators 50 without microcontrollers are possible. Also, the fans and heater units may be controlled directly by an operator via a control panel.

While specific interconnections within the control portion 155 are disclosed, and certain quantities of components and/or specific part numbers are disclosed, other connections, configurations, and quantities are possible. For example, connections within the control portion 155 may be made via a single bus (e.g., an I²C bus or controller area network (CAN) bus), or there may be more or fewer of the components shown (e.g., current drivers, air temperature sensors, etc). The control portion may also include an internal power supply that provides worldwide power input capability by accepting varying input voltages and/or frequencies.

At least some alternative embodiments of simulators may be installed in the rack using slides (not shown), be constructed to resemble tabletop network devices (e.g., by omitting the rack ears), or use binding posts as the power connections to the simulator.

While the invention has been discussed in the context of a “data center” and “IT equipment,” the invention is not so limited. The invention may be used to simulate other types of equipment in different industries and settings. For example, the invention may be used to simulate recording equipment at a recording studio, simulate flight equipment in an aircraft, simulate laboratory equipment, etc. “IT equipment” also refers to any other type of equipment such as DVD players, cable boxes, aircraft equipment, telephone equipment, laboratory test equipment, etc. For example, simulators may be used in an aircraft to simulate the presence of flight hardware.

The use of the term “invention” also includes the plural “inventions.”

Other embodiments are within the scope and spirit of the appended claims. For example, due to the nature of software, functions described above can be implemented using software, hardware, firmware, hardwiring, or combinations of any of these. Features implementing functions may also be physically located at various positions, including being distributed such that portions of functions are implemented at different physical locations.

What is claimed is:

1. An IT equipment simulator for simulating IT equipment, the simulator comprising:
a housing sized to fit in a standard IT equipment rack, the housing is configured to provide an airflow characteristic substantially equal to the IT equipment under simulation;
a variable electric load disposed in the housing; and
a fan disposed in the housing and configured to produce airflow such that air flows into the housing, absorbs heat from the load, and flows out of the housing;
wherein the housing is substantially free of further IT equipment.

2. The IT equipment simulator of claim 1 wherein a fan speed is user selectable.

3. The IT equipment simulator of claim 1 wherein the fan is configured to produce airflow such that air flows into the housing through a front of the housing, and flows out a back of the housing.

4. The IT equipment simulator of claim 1 wherein the housing, the variable electric load, and the fan are configured to provide a substantially constant temperature rise of the air flowing out of the housing relative to air flowing in to the housing.

5. The IT equipment simulator of claim 1 wherein the fan is configured to produce a set of discrete rates of airflow.

6. The IT equipment simulator of claim 1 further comprising a controller, wherein the controller is configured to adjust a volume of airflow produced by the fan.

7. The IT equipment simulator of claim 6 further comprising a sensor, wherein the controller is configured to adjust the volume of airflow produced by the fan in response to data received from the sensor.

8. The IT equipment simulator of claim 7 wherein the sensor is configured to measure at least one of airflow speed, airflow volume, inlet temperature, exhaust temperature, input voltage, input frequency, current draw, power draw, temperature rise, and power factor.

9. The IT equipment simulator of claim 1 further comprising a controller coupled to the load, the controller is configured to alter the power consumed by the load.

10. The IT equipment simulator of claim 1 further comprising a controller and a temperature sensor, wherein the controller is configured to control, in response to information received from the sensor, power consumed by the load.

11. The IT equipment simulator of claim 1 further comprising a controller, a sensor, and a communication port, the sensor being configured to transmit information via the communication port, the load being configured to vary in response to information received from the communication port.

12. The IT equipment simulator of claim 1 further comprising a sensor and a communication port coupled to the sensor and the fan, the sensor being configured to transmit data via the communication port, the fan being configured to vary speed in response to information received from the communication port.

13. The IT equipment simulator of claim 12 wherein the communication port is an Ethernet port.

14. The IT equipment simulator of claim 1 further comprising a controller and a memory that includes load and airflow setting information.

15. The IT equipment simulator of claim 14 wherein the memory contains operational profiles of the simulated IT equipment.

16. The IT equipment simulator of claim 15 wherein the controller is configured to set an airflow based on a selected one of the operational profiles.

17. The IT equipment simulator of claim 15 wherein the controller is configured to provide a power consumption value to the load based on a selected one of the operational profiles.

18. The IT equipment simulator of claim 15 wherein the controller is configured to implement a fan control algorithm based on a selected one of the operational profiles.

19. The IT equipment simulator of claim 1 further comprising a controller disposed within the housing.

20. The IT equipment simulator of claim 1 further comprising a sensor.

21. The IT equipment simulator of claim 1 further comprising a controller and a communication port, the controller being coupled to the communication port, wherein the controller controls operating characteristics of the IT equipment simulator in response to data received by the communication port.

22. The IT equipment simulator of claim 1 further comprising a controller and a communication port, the controller being coupled to the communication port, wherein the fan is coupled to the controller and the controller is configured to adjust a volume of airflow produced by the fan in response to data received by the communication port.

23. The IT equipment simulator of claim 1 further comprising a controller and a communication port, the controller being coupled to the communication port, wherein the controller is configured to control a power factor of the IT equipment simulator in response to data received by the communication port.

24. The IT equipment simulator of claim 1 wherein the variable electric load is a resistive heater.

25. The IT equipment simulator of claim 1 wherein the variable electric load is configured to vary in discrete incremental steps.

26. The IT equipment simulator of claim 1 wherein a height of the housing is substantially one of: 2 rack units (U), 7U, and 10U.

27. The IT equipment simulator of claim 1 wherein the housing is substantially similar to a housing of the simulated IT equipment.

28. The IT equipment simulator of claim 1 further comprising a simulated network connector.

29. The IT equipment simulator of claim 1 further comprising:
a first network port;
a second network port; and
a network bypass relay connected to the first network port and the second network port, the network bypass relay being configured to communicate a network signal from the first network port to the second network port when the IT equipment simulator is non-functional.

30. The IT equipment simulator of claim 1 wherein the IT equipment simulator is configured to substantially conform to the IEC-61010-1:2001 safety standard.

31. The IT equipment simulator of claim 1 wherein the IT equipment simulator is configured to provide a substantially uniform exhaust airflow pattern over an exhaust port provided by the housing.

32. The IT equipment simulator of claim 1 wherein the IT equipment simulator is configured to provide a substantially uniform temperature difference between air flowing into the housing and air flowing out of the housing.

33. An IT equipment simulator for simulating at least one piece of IT equipment, the simulator comprising:
a housing sized to fit in a standard IT equipment rack, the housing is configured to provide an airflow characteristic substantially equal to the IT equipment under simulation;
a removable modular variable electric load;
a fan disposed in the housing to produce airflow such that air flows into the housing, absorbs heat from the load, and flows out of the housing;
a communication input;
a controller coupled to the communication input, the fan, and the removable electric load, the controller being configured to adjust a volume of airflow produced by the fan and power consumed by the load; and
a memory coupled to the controller;
wherein the housing is substantially free of further IT equipment.

34. The IT equipment simulator of claim 33 wherein the variable electric load is a resistive heater.

35. The IT equipment simulator of claim 33 wherein the memory contains operational profiles of the IT equipment.

36. The IT equipment simulator of claim 35 wherein the controller is configured to set an airflow based on a selected one of the operational profiles.

37. The IT equipment simulator of claim 35 wherein the controller is configured to provide a power consumption value to the load based on a selected one of the operational profiles.

38. The IT equipment simulator of claim 35 wherein the controller is configured to implement a fan control algorithm based on a selected one of the operational profiles.

39. The IT equipment simulator of claim 33 further comprising at least one of a temperature sensor and an airflow sensor, wherein the controller is configured to adjust a volume of airflow provided by the fan as a function of data received from the at least one sensor.

40. A method for simulating an installation of IT equipment in a facility including a power distribution system and a cooling system, the method comprising:
providing equipment simulators in at least one equipment rack, the equipment simulators each comprising a housing, a variable electric load, and a variable airflow source;
powering the equipment simulators from the power distribution system;
inducing a first airflow substantially similar to a second airflow of the IT equipment;
inducing a first power consumption substantially similar to a second power consumption of the IT equipment; and
analyzing an operational characteristic of the equipment installation.

41. The method of claim 40 wherein inducing the first power consumption comprises regulating the loads using an automatic controller.

42. The method of claim 40 wherein inducing the first airflow comprises regulating the airflow source using an automatic controller.

43. The method of claim 40 further comprising:
drawing air in through fronts of the equipment simulators;
heating the air to simulate heat produced by the IT equipment when installed in the installation; and
exhausting the air through rears of the equipment simulators.

44. The method of claim 40 further comprising controlling the equipment simulators using at least one communication port coupled to the equipment simulators.

45. The method of claim 40 further comprising configuring the equipment simulators using at least one communication port coupled to the equipment simulators.

46. The method of claim 40 further comprising monitoring the equipment simulators using at least one communication port coupled to the equipment simulators.

47. The method of claim 40 further comprising connecting at least one cable to at least one of the simulators to simulate a cabling arrangement in the installation.
